(19) United States
(12) Patent Application Publication
(10) Pub. No.: US 2025/0085908 A1
(43) Pub. Date: Mar. 13, 2025

(54) MANAGEMENT SYSTEM AND CONTROL METHOD FOR MANAGEMENT DEVICE

(71) Applicant: SEIKO EPSON CORPORATION, Tokyo (JP)

(72) Inventor: Masanori KOIZUMI, Suwa (JP)

(21) Appl. No.: 18/830,688

(22) Filed: Sep. 11, 2024

(30) Foreign Application Priority Data
Sep. 13, 2023 (JP) 2023-148391

(51) Int. Cl. G06F 3/12

(52) U.S. Cl. CPC G06F 3/1239; G06F 3/1219; G06F 3/1222

(57) ABSTRACT

There is provided a control method for a management device that manages a storage container that stores a consumable item used in a printing apparatus, the method causing a processor of the management device to function as a granting unit configured to grant a privilege of a first amount to a user when the user brought in a first number of storage containers in a collecting action of bringing the storage container into collection equipment for collecting the storage container and grant the privilege of a second amount to the user when the user brought in a second number of storage containers more than the first number of storage containers in the collecting action. A value obtained by dividing the second amount by the second number is larger than a value obtained by dividing the first amount by the first number.

The present application is based on, and claims priority from JP Application Serial Number 2023-148391, filed Sep. 13, 2023, the disclosure of which is hereby incorporated by reference herein in its entirety.

### BACKGROUND

### 1. Technical Field

The present disclosure relates to a management system and a control method for a management device.

### 2. Related Art

As disclosed in JP-A-2003-039708, there has been known a method of individually collecting a storage container that stores a consumable item used in a printing apparatus and reusing the collected storage container.

JP-A-2003-039708 is an example of the related art.

However, as in the related art, when the storage container is individually collected and the collected storage container is reused, a problem in that an environmental load relating to the collection of the storage container increases sometimes occurs. For this reason, in the related art, there is room for improvement concerning, for example, the target 12 “ensure a sustainable production mode” among SDGs, that is, the seventeen sustainable development targets adopted in the UN General Assembly on Sep. 25, 2015.

The problem described above is not a problem limited to a scene of collection of a storage container that stores a consumable item used in a printing apparatus and is relevant to, for example, a scene of collection of a reusable member in general.

### SUMMARY

In order to solve the problems described above, a control method for a management device according to the present disclosure is a control method for a management device that manages a storage container that stores a consumable item used in a printing apparatus, the method causing a processor of the management device to function as a granting unit configured to: grant a privilege of a first amount to a user when the user brought in a first number of storage containers in a collecting action of bringing the storage container into collection equipment for collecting the storage container; and grant the privilege of a second amount to the user when the user brought in a second number of storage containers more than the first number of storage containers in the collecting action, wherein a value obtained by dividing the second amount by the second number is larger than a value obtained by dividing the first amount by the first number.

A management system according to the present disclosure is a management system that manages a reusable specific member, the management system including a granting unit configured to: grant a privilege of a first amount to a user when the user brought in a first number of specific members in a collecting action of bringing the specific member into collection equipment for collecting the specific member; and grant the privilege of a second amount to the user when the user brought in a second number of specific members more than the first number of storage containers in the collecting action, wherein a value obtained by dividing the second amount by the second number is larger than a value obtained by dividing the first amount by the first number.

### BRIEF DESCRIPTION OF THE DRAWINGS

FIG. 1 is a block diagram illustrating an example of a configuration of a management system according to an embodiment of the present disclosure.

FIG. 2 is a block diagram illustrating an example of a configuration of a cartridge.

FIG. 3 is a block diagram illustrating an example of a configuration of a user card.

FIG. 4 is a block diagram illustrating an example of a configuration of a collection box.

FIG. 5 is a block diagram illustrating an example of a configuration of a management server.

FIG. 6 is a diagram illustrating an example of point grant information.

FIG. 7 is a diagram illustrating another example of the point grant information.

FIG. 8 is a sequence chart illustrating an example of an operation of the management system.

FIG. 9 is a sequence chart illustrating an example of an operation of the management system.

### DESCRIPTION OF EMBODIMENTS

A mode for carrying out the present disclosure is explained below with reference to the drawings. In the respective figures, dimensions and scales of units are differentiated from actual one as appropriate. Since embodiments explained below are preferred specific examples of the present disclosure, the embodiments are added with various technically desirable limitations. However, the scope of the present disclosure is not limited to these embodiments unless there is particularly a description to the effect that the present disclosure is limited.

### A. Embodiment

In an embodiment, a management system Sys that manages a cartridge 7 that stores ink used in a printing apparatus PR is explained as an example.

### 1. Configuration of the Management System

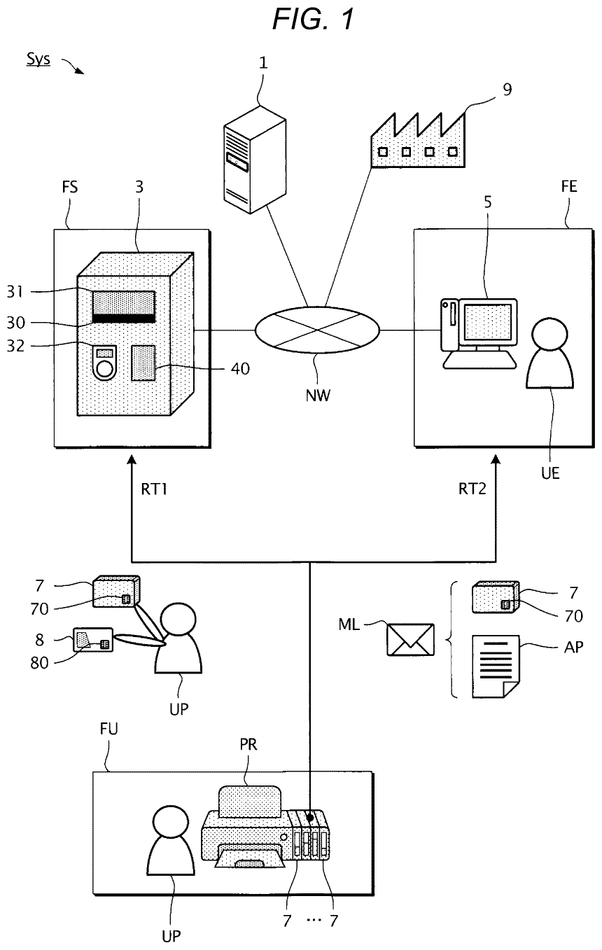

In the following explanation, an example of a configuration of the management system Sys according to the present embodiment is explained with reference to FIGS. 1 to 5.

FIG. 1 is a block diagram illustrating the example of the configuration of the management system Sys.

As illustrated in FIG. 1, the management system Sys includes a management server 1, one or a plurality of collection boxes 3, one or a plurality of collection reception terminals 5, and a recycling factory 9 and manages the cartridge 7 that stores ink used in the printing apparatus PR.

The management server 1 is a server device for managing the cartridge 7. Here, the cartridge 7 is a container that stores the ink used in the printing apparatus PR and is a container that can be attached to the printing apparatus PR.

In the present embodiment, the management server 1 is an example of a “management device”, the ink is an example of a “consumable item”, and the cartridge 7 is an example of a “storage container”.

The collection box 3 is equipment for collecting the used cartridge 7 from a user UP of the printing apparatus PR. Here, the used cartridge 7 is, for example, the cartridge 7 in which a residual amount of the ink stored therein is small or the cartridge 7 in which the ink stored therein is deteriorated. That is, in the present embodiment, even if the ink remains inside the cartridge 7, the collection box 3 can collect the cartridge 7.

In the present embodiment, the collection box 3 is installed in a commercial facility FS. Here, the commercial facility FS is a commercial facility such as an electronics retail store that sells the printing apparatus PR or a shopping mall that sells various commodities, a public facility such as a public hall, a medical facility such as a hospital, or the like.

In the present embodiment, the collection box 3 is an example of “collection equipment”.

The collection reception terminal 5 is a terminal device provided in a collection center FE. Specifically, when the user UP of the printing apparatus PR mails the used cartridge 7 to the collection center FE, the collection reception terminal 5 is a terminal device for a staff member UE of the collection center FE inputting information concerning the cartridge 7 mailed by the user UP. The collection center FE is a facility for collecting the used cartridge 7 from the user UP of the printing apparatus PR.

In the present embodiment, the collection center FE is another example of the “collection equipment”.

The recycling factory 9 is a facility for recycling, as a recycled product, the used cartridge 7 collected from the user UP in the collection box 3 or the collection center FE. Specifically, the recycling factory 9 is a facility that cleans the used cartridge 7 and then refills the cleaned cartridge 7 with ink to manufacture a recycled product of the cartridge 7. However, the recycling factory 9 may disassemble the used cartridge 7 into materials and then use the disassembled materials to manufacture the recycled product of the cartridge 7. The recycling factory 9 may disassemble the used cartridge 7 into materials and then use the disassembled materials to manufacture a commodity different from the cartridge 7 as a recycled product.

In the present embodiment, it is assumed that the printing apparatus PR is provided in a user facility FU. Here, the user facility FU is a facility where the user UP uses the printing apparatus PR, such as a home of the user UP or an office of the user UP.

In the present embodiment, as an example, it is assumed that there are two collection routes, that is, a user bringing collection route RT1 and a mailing collection route RT2, as collection routes for the used cartridge 7.

The user bringing collection route RT1 is a route through which the user UP brings the cartridge 7 used in the user facility FU to the collection box 3 provided in the commercial facility FS and the used cartridge 7 is collected from the user UP. Note that, in the present embodiment, when the used cartridge 7 is collected through the user bringing collection route RT1, as an example, it is assumed that, when the user UP puts the used cartridge 7 in the collection box 3, authentication for the user UP is performed by a user card 8 carried by the user UP.

In the present embodiment, an action of the user UP bringing the cartridge 7 to the collection box 3 of the commercial facility FS is an example of a “collecting action”.

The mailing collection route RT2 is a route for mailing the used cartridge 7 from the user facility FU to the collection center FE to collect the used cartridge 7 from the user UP. In the present embodiment, it is assumed that, when the used cartridge 7 is collected from the mailing collection route RT2, as an example, the user UP sends a mail ML enclosing the used cartridge 7 and a collection application AP to the collection center FE.

In the present embodiment, the action of the user UP mailing the cartridge 7 to the collection center FE is another example of the “collecting action”.

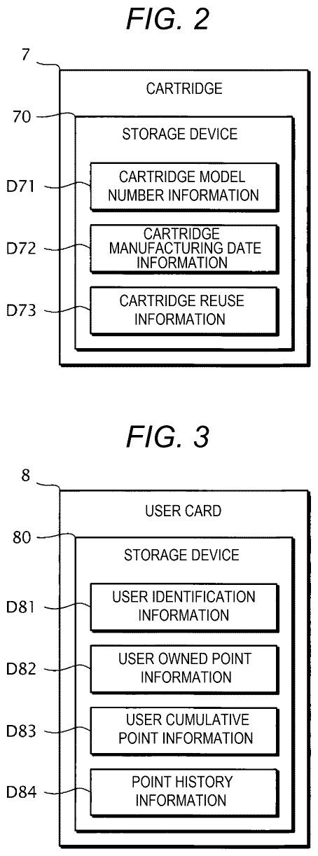

FIG. 2 is a block diagram illustrating an example of a configuration of the cartridge 7.

As illustrated in FIG. 2, the cartridge 7 includes a storage device 70. The cartridge 7 is provided with an ink storage chamber (not illustrated) that stores ink.

The storage device 70 is, for example, an IC chip and stores cartridge model number information D71, cartridge manufacturing date information D72, and cartridge reuse information D73.

The cartridge model number information D71 is information indicating a model number of a product of the cartridge 7.

In the present embodiment, the cartridge model number information D71 is an example of “container information”.

The cartridge manufacturing date information D72 is information indicating a date of manufacture of the cartridge 7.

The cartridge reuse information D73 is information indicating the number of times the cartridge 7 is recycled as a recycled product. Specifically, the cartridge reuse information D73 indicates “0” when the cartridge 7 is a new product before recycling and indicates a numerical value of “1” or more when the cartridge 7 is a recycled product.

FIG. 3 is a block diagram illustrating an example of a configuration of the user card 8.

As illustrated in FIG. 3, the user card 8 includes a storage device 80 that stores information concerning points usable by the user UP. In the present embodiment, it is assumed that, when the user UP purchases a recycled product of the cartridge 7, a part or all of an amount of the purchase can be replaced with a point. In the present embodiment, it is assumed that, when the user UP has purchased a commodity in the commercial facility FS, a part or all of an amount of the purchase can be replaced with a point. That is, in the present embodiment, as an example, it is assumed that the point is exchangeable with the recycled product of the cartridge 7 and the point is exchangeable with a commodity that can be purchased in the commercial facility FS. However, the present disclosure is not limited to such an aspect. The point only has to be at least exchangeable with a recycled product of the cartridge 7.

Further, in the present embodiment, the point is granted to the user UP when the user UP has brought the used cartridge 7 into the collection box 3, when the user UP has mailed the used cartridge 7 to the collection center FE, and when the user UP has purchased a commodity in the commercial facility FS. However, the present disclosure is not limited to such an aspect. The point only has to be granted to the user UP at least when the user UP has brought the used cartridge 7 into the collection box 3 and when the user UP has mailed the used cartridge 7 to the collection center FE. That is, the point only has to be granted to the user UP at least when the user UP has performed the collecting action.

In the present embodiment, the point is an example of a “privilege”.

The storage device 80 is, for example, an IC chip and stores user identification information D81, user owned point information D82, user cumulative point information D83, and point history information D84.

The user identification information D81 is information indicating a user ID for uniquely identifying each user out of a plurality of users who own user cards 8. In the present embodiment, it is assumed that a user who owns the user card 8 is the user UP who uses the printing apparatus PR. However, the present disclosure is not limited to such an aspect. The user who owns the user card 8 may be the user UP who uses the printing apparatus PR and a user who uses the commercial facility FS. The user who owns the user card 8 may be a user who uses the cartridge 7.

The user owned point information D82 is information indicating the number of points owned by the user UP. Here, the number of points is a quantity of points.

The user cumulative point information D83 is information indicating a cumulative value of the number of points acquired by the user UP from the start of management of the user UP by the management system Sys to the present. Here, the management of the user UP by the management system Sys may be started, for example, at timing when the user UP purchases the printing apparatus PR. The management of the user UP by the management system Sys may be started, for example, at timing when the user UP purchases the cartridge 7.

The point history information D84 is information indicating the application history of points to the user UP and the usage history of points by the user UP in a period from the start of the management of the user UP by the management system Sys to the present.

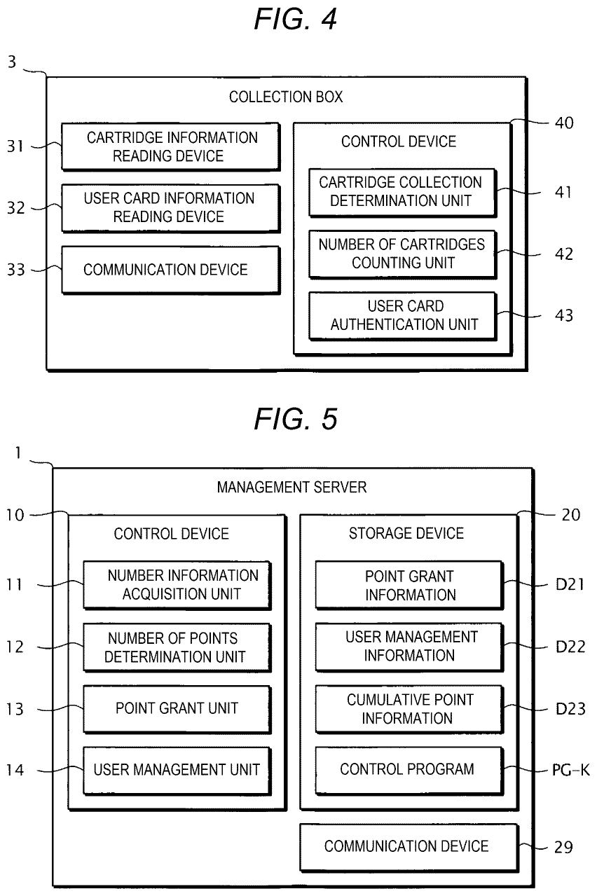

FIG. 4 is a block diagram illustrating an example of a configuration of the collection box 3.

As illustrated in FIGS. 1 and 4, the collection box 3 includes a cartridge insertion slot 30, a cartridge information reading device 31, a user card information reading device 32, a communication device 33, and a control device 40.

The cartridge insertion slot 30 is an opening for the user UP to insert the cartridge 7 into a cartridge storage space (not illustrated) provided inside the collection box 3.

When the cartridge 7 is inserted into the cartridge insertion slot 30, the cartridge information reading device 31 reads, from the storage device 70 provided in the cartridge 7, the cartridge model number information D71, the cartridge manufacturing date information D72, and the cartridge reuse information D73 stored in the storage device 70. However, the present disclosure is not limited to such an aspect. When the cartridge 7 is inserted into the cartridge insertion slot 30, the cartridge information reading device 31 only has to read at least the cartridge model number information D71 stored in the storage device 70 from the storage device 70 provided in the cartridge 7.

In the present embodiment, the cartridge information reading device 31 is an example of a “reading device”.

When the user UP touches the user card information reading device 32 with the user card 8, the user card information reading device 32 reads, from the storage device 80 provided in the user card 8, the user identification information D81, the user owned point information D82, the user cumulative point information D83, and the point history information D84 stored in the storage device 80. However, the present disclosure is not limited to such an aspect. When the user UP touches the user card information reading device 32 with the user card 8, the user card information reading device 32 only has to read at least the user identification information D81 from the storage device 80 provided in the user card 8.

The communication device 33 is hardware for communicating with, via one or both of a wired network and a wireless network, an external device present outside the collection box 3.

The control device 40 includes a cartridge collection determination unit 41, a number of cartridges counting unit 42, and a user card authentication unit 43.

The cartridge collection determination unit 41 determines, based on a reading result by the cartridge information reading device 31, whether an object inserted into the cartridge insertion slot 30 corresponds to the cartridge 7 that can be collected by the collection box 3. Specifically, the cartridge collection determination unit 41 determines whether a model number indicated by the cartridge model number information D71 read by the cartridge information reading device 31 is a model number corresponding to the cartridge 7 that can be collected by the collection box 3.

In the present embodiment, the cartridge collection determination unit 41 is an example of a “product determination unit”.

When the model number indicated by the cartridge model number information D71 read by the cartridge information reading device 31 is the model number corresponding to the cartridge 7 that can be collected by the collection box 3, the cartridge collection determination unit 41 determines that the object inserted into the cartridge insertion slot 30 corresponds to the cartridge 7 that can be collected by the collection box 3. When the model number indicated by the cartridge model number information D71 read by the cartridge information reading device 31 is not the model number corresponding to the cartridge 7 that can be collected by the collection box 3, the cartridge collection determination unit 41 determines that the object inserted into the cartridge insertion slot 30 does not correspond to the cartridge 7 that can be collected by the collection box 3. When the cartridge information reading device 31 has failed in reading the cartridge model number information D71, the cartridge collection determination unit 41 determines that the object inserted into the cartridge insertion slot 30 does not correspond to the cartridge 7 that can be collected by the collection box 3.

When a result of the determination by the cartridge collection determination unit 41 is affirmative, that is, when the object inserted into the cartridge insertion slot 30 corresponds to the cartridge 7 that can be collected by the collection box 3, the collection box 3 stores the cartridge 7 in the cartridge storage space in the collection box 3. On the other hand, when the result of the determination by the cartridge collection determination unit 41 is negative, that is, when the object inserted into the cartridge insertion slot 30 does not correspond to the cartridge 7 that can be collected by the collection box 3, the collection box 3 discharges the object to the outside of the collection box 3.

The number of cartridges counting unit 42 generates, based on the determination result by the cartridge collection determination unit 41, number of cartridges information DK indicating the number of the cartridges 7 inserted into the cartridge insertion slot 30.

In the present embodiment, the number of cartridges counting unit 42 is an example of a “number information generation unit” and the number of cartridges information DK is an example of “number information”.

Here, the number of cartridges information DK is information indicating the number of the cartridges 7 inserted into the cartridge insertion slot 30 by the user UP in one collecting action in which the user UP brings the cartridge 7 into the commercial facility FS in order to put the cartridge 7 in the collection box 3. For example, the number of cartridges information DK may be information indicating the number of cartridges 7 inserted into the cartridge insertion slot 30 by the user UP in a period from when the user UP authenticates the user UP with the user card 8 to when, for example, the user UP presses an insertion completion button (not illustrated) installed in the collection box 3 to end the insertion of the cartridge 7 by the user UP. For example, the number of cartridges information DK may be information indicating the number of the cartridges 7 inserted into the cartridge insertion slot 30 by the user UP in a period until the user UP visiting the commercial facility FS leaves the commercial facility FS. In the following explanation, the number of the cartridges 7 indicated by the number of cartridges information DK, that is, the number of the cartridges 7 inserted into the cartridge insertion slot 30 by the user UP in one collecting action is sometimes referred to as number of collected cartridges KK.

In the present embodiment, one collecting action is one visiting action to the commercial facility FS by the user UP in which one or a plurality of cartridges 7 are brought to the collection box 3 provided in the commercial facility FS. In the present embodiment, one collecting action may be one mailing action to the collection center FE by the user UP in which one or a plurality of cartridges 7 are mailed to the collection center FE as a mail ML.

When the user card information reading device 32 is touched by the user card 8, the user card authentication unit 43 specifies, based on the user identification information D81 stored in the storage device 80 provided in the user card 8, a user ID of the user UP who owns the user card 8.

In the following explanation, the management server 1 according to the present embodiment is explained with reference to FIGS. 5 to 7.

FIG. 5 is a block diagram illustrating an example of a configuration of the management server 1.

As illustrated in FIG. 5, the management server 1 includes a control device 10, a storage device 20, and a communication device 29.

The communication device 29 is hardware for communicating with, via one or both of a wired network and a wireless network, an external device present outside the management server 1.

The storage device 20 includes a volatile memory such as a RAM (Random Access Memory) functioning as a work area of the control device 10 and a nonvolatile memory such as an EEPROM (Electrically Erasable Programmable Read-Only Memory) that stores various information. In the present embodiment, the storage device 20 stores point grant information D21, user management information D22, cumulative point information D23, and a control program PG-K for controlling the units of the management server 1.

The control device 10 includes a processor. The processor of the control device 10 includes, for example, one or a plurality of CPUs (Central Processing Units). In the present embodiment, the processor of the control device 10 can function as a number information acquisition unit 11, a number of points determination unit 12, a point grant unit 13, and a user management unit 14 by executing the control program PG-K stored in the storage device 20 and operating according to the control program PG-K. The processor of the control device 10 may include hardware such as a GPU (Graphics Processing Unit), a DSP (Digital Signal Processor), or an FPGA (Field Programmable Gate Array) in addition to the one or the plurality of CPUs or instead of a part or all of the one or the plurality of CPUs. In this case, a part or all of functions implemented by the processor of the control device 10 may be implemented by the hardware such as the DSP.

The number information acquisition unit 11 acquires the number of cartridges information DK from the collection box 3.

In the present embodiment, the number information acquisition unit 11 is an example of an “acquisition unit”.

The number of points determination unit 12 determines the number of points granted to the user UP based on the number of cartridges information DK acquired by the number information acquisition unit 11 and the point grant information D21 stored in the storage device 20.

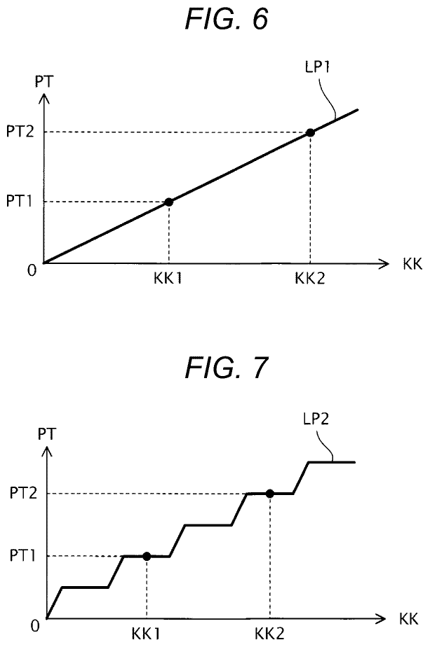

FIG. 6 is a diagram illustrating an example of the point grant information D21.

As illustrated in FIG. 6, the point grant information D21 is information for specifying a relation between the number of collected cartridges KK and a unit number of points PT.

Here, the unit number of points PT is, when the user UP has inserted one or a plurality of cartridges 7 into the cartridge insertion slot 30, the number of points granted to the user UP to correspond to one cartridge 7 among the inserted one or the plurality of cartridges 7. That is, in the present embodiment, it is assumed that, when the number of the cartridges 7 inserted into the cartridge insertion slot 30 in one collecting action by the user UP is the number of collected cartridges KK, the management system Sys grants the number of points “KK*PT” obtained by multiplying together the unit number of points PT and the number of collected cartridges KK to the user UP.

In the present embodiment, as indicated by a relation line LP1 in FIG. 6, when values KK1 and KK2 are natural numbers satisfying “1≤KK1<KK2”, the unit number of points PT corresponding to “KK1” of the number of collected cartridges KK is “PT1” and the unit number of points PT corresponding to “KK2” of the number of collected cartridges KK is “PT2”. In the present embodiment, a relation between the number of collected cartridges KK and the unit number of points PT is specified such that “0<PT1<PT2” is established between the unit number of points PT1 and the unit number of points PT2. However, the number of collected cartridges KK and the unit number of points PT indicated by the point grant information D21 are not limited to an aspect having the relation indicated by the relation line LP1 in FIG. 6. For example, as indicated by a relation line LP2 in FIG. 7, when the value KK1 and the value KK2 are natural numbers satisfying “1≤KK1<KK2”, the relation between the number of collected cartridges KK and the unit number of points PT may be specified such that the unit number of points PT1 corresponding to “KK1” of the number of collected cartridges KK and the unit number of points PT2 corresponding to “KK2” of the number of collected cartridges KK satisfy “0<PT1≤PT2”.

In FIGS. 6 and 7, when the number of collected cartridges KK is “KK1”, the number of points granted to the user UP is “KK1*PT1” and, when the number of collected cartridges KK is “KK2”, the number of points granted to the user UP is “KK2*PT2”.

Here, “KK1” is an example of a “first number”, “KK2” is an example of a “second number”, “KK1*PT1” is an example of a “first amount”, “KK2*PT2” is an example of a “second amount”, the unit number of points PT1 is an example of a “value obtained by dividing the first amount by the first number”, and the unit number of points PT2 is an example of a “value obtained by dividing the second amount by the second number”.

The point grant unit 13 illustrated in FIG. 5 grants the number of points determined by the number of points determination unit 12 to the user UP. In the following explanation, information indicating the number of points granted to the user UP by the point grant unit 13 is sometimes referred to as granted point information DP.

In the present embodiment, the point grant unit 13 is an example of a “granting unit”.

The user management unit 14 updates the user management information D22 when the point grant unit 13 grants a point to the user UP and when the user UP uses a point.

Here, the user management information D22 is information including information indicating a user ID for identifying the user UP, information indicating the number of points owned by the user UP, information indicating a history of points granted to the user UP, information indicating a history of points used by the user UP, and information indicating a cumulative value of points granted to the user UP. That is, the user management information D22 is information indicating the same contents as the user identification information D81, the user owned point information D82, the user cumulative point information D83, and the point history information D84.

In the present embodiment, the user management information D22 is an example of “history information”.

In the present embodiment, as an example, it is assumed that the storage device 80 stores the user identification information D81, the user owned point information D82, the user cumulative point information D83, and the point history information D84 and the storage device 20 stores the user management information D22. However, the present disclosure is not limited to such an aspect. For example, the storage device 80 only has to store at least the user identification information D81 indicating the user ID and may not store the user owned point information D82, the user cumulative point information D83, and the point history information D84.

In the present embodiment, it is assumed that the management system Sys grants a point to the user UP when a cumulative value of the number of points acquired by the user UP satisfies a specific condition in addition to the management system Sys granting a point to the user UP when the user UP has performed the collecting action.

In the following explanation, the cumulative value of the number of points acquired by the user UP is sometimes referred to as cumulative acquired point. In the following explanation, the point granted to the user UP when the cumulative value of the number of points acquired by the user UP satisfies the specific condition is sometimes referred to as cumulative granted point.

In the present embodiment, the number of points determination unit 12 determines, based on the cumulative acquired point of the user UP and the cumulative point information D23, a quantity of a cumulative granted point granted to the user UP. Then, the point grant unit 13 grants a point corresponding to a quantity of the cumulative granted point determined by the number of points determination unit 12 to the user UP.

Here, the cumulative point information D23 is information for specifying a relation between the cumulative acquired point of the user UP and the quantity of the cumulative granted point to be granted to the user UP. In the present embodiment, as explained above, it is assumed that the cumulative granted point is granted to the user UP when the cumulative acquired point of the user UP satisfies the specific condition. In the present embodiment, it is assumed that the cumulative granted point is not granted to the user UP when the cumulative acquired point of the user UP does not satisfy the specific condition. For this reason, the cumulative point information D23 may be information indicating a specific condition to be satisfied by the cumulative acquired point. Here, the specific condition may be, for example, a condition that the cumulative acquired point has a specific value or a condition that the cumulative acquired point is a multiple of a specific value.

### 2. Operation of the Management System

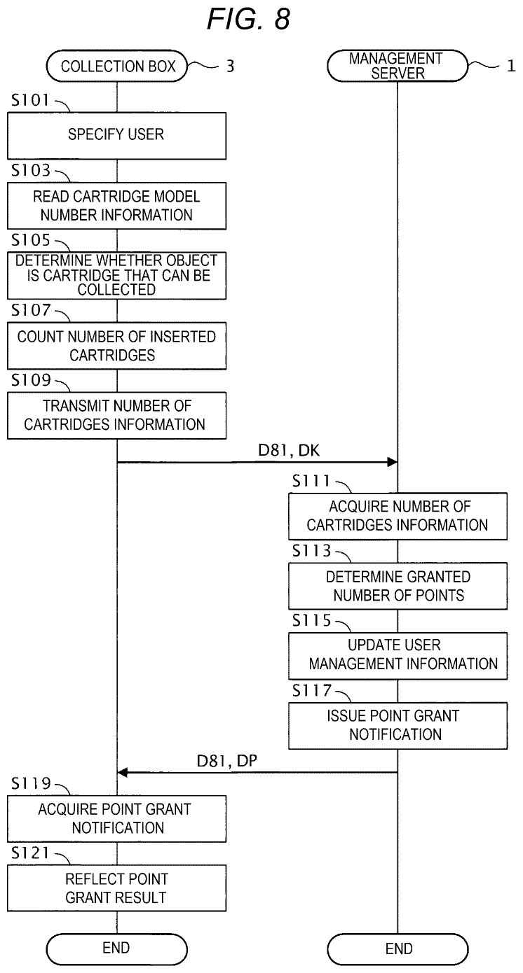

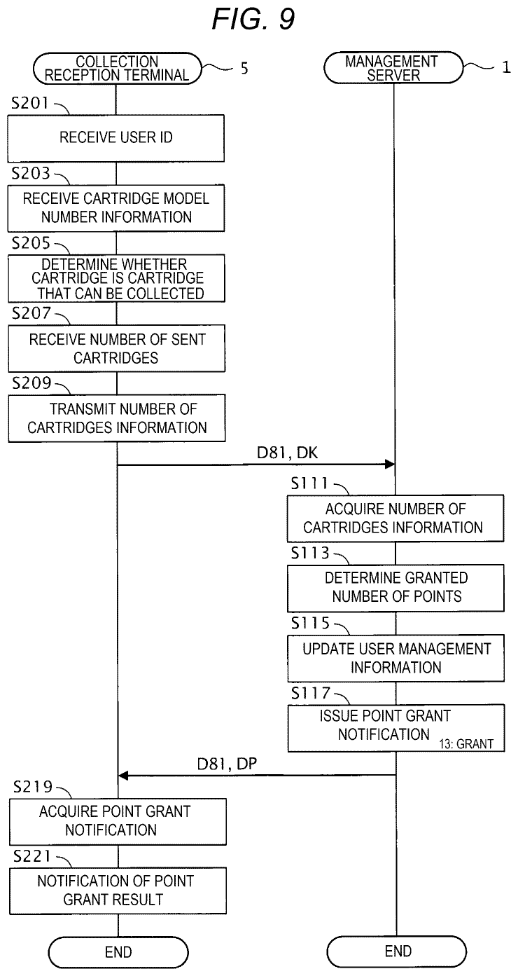

In the following explanation, an example of an operation of the management system Sys according to the present embodiment is explained with reference to FIGS. 8 to 9.

FIG. 8 is a sequence chart illustrating an example of processing of the management system Sys in the case in which the user UP performs the collecting action by the user bringing collection route RT1. In the following explanation, the processing of the management system Sys in the case in which the user UP performs the collecting action by the user bringing collection route RT1 is referred to as user bringing collection processing.

As illustrated in FIG. 8, in the user bringing collection processing, when the user UP touches the user card information reading device 32 with the user card 8 and the user card information reading device 32 reads the user identification information D81 from the storage device 80 provided in the user card 8, the user card authentication unit 43 of the collection box 3 specifies, based on the user identification information D81, a user ID of the user UP who owns the user card 8 (S101).

Subsequently, when the user UP inserts the cartridge 7 into the cartridge insertion slot 30, the control device 40 of the collection box 3 controls the cartridge information reading device 31 to read information such as the cartridge model number information D71 stored in the storage device 70 provided in the cartridge 7 (S103).

Subsequently, the cartridge collection determination unit 41 of the collection box 3 determines, based on a reading result by the cartridge information reading device 31 in step S103, whether the object inserted into the cartridge insertion slot 30 corresponds to the cartridge 7 that can be collected by the collection box 3 (S105).

Subsequently, the number of cartridges counting unit 42 of the collection box 3 generates, based on a determination result by the cartridge collection determination unit 41 in step S105, the number of cartridges information DK indicating the number of the cartridges 7 inserted into the cartridge insertion slot 30 (S107).

Subsequently, the number of cartridges counting unit 42 of the collection box 3 controls the communication device 33 to transmit the user identification information D81 for identifying the user UP specified in step S101 and the number of cartridges information DK generated in step S107 to the management server 1 (S109).

Thereafter, the number information acquisition unit 11 of the management server 1 acquires the number of cartridges information DK and the user identification information D81 transmitted by the number of cartridges counting unit 42 in step S109 (S111).

Subsequently, the number of points determination unit 12 of the management server 1 determines, based on the number of cartridges information DK acquired by the number information acquisition unit 11 in step S111 and the point grant information D21 stored in the storage device 20, the number of points granted to the user UP (S113).

Subsequently, the user management unit 14 of the management server 1 updates, based on a determination result of the number of points determination unit 12 in step S113, the user management information D22 corresponding to the user UP indicated by the user identification information D81 acquired by the number information acquisition unit 11 in step S111 (S115). Specifically, in step S115, the user management unit 14 updates the number of points owned by the user UP indicated by the user identification information D81, the history of the points granted to the user UP indicated by the user identification information D81, and the cumulative value of the points granted to the user UP indicated by the user identification information D81 in the user management information D22.

Subsequently, the point grant unit 13 of the management server 1 issues a point grant notification (S117) Here, the point grant notification is a notification indicating that the number of points determined by the number of points determination unit 12 in step S113 has been granted to the user UP indicated by the user identification information D81 acquired by the number information acquisition unit 11 in step S111. Specifically, the point grant notification is information including the user identification information D81 acquired by the number information acquisition unit 11 in step S111 and the granted point information DP indicating the number of points determined by the number of points determination unit 12 in step S113.

Thereafter, the control device 40 of the collection box 3 acquires the point grant notification transmitted by the point grant unit 13 in step S117 (S119).

Next, the control device 40 of the collection box 3 reflects a point grant result on the user card 8 (S121). Specifically, in step S121, the control device 40 controls the user card information reading device 32 to update, based on the point grant notification, the user owned point information D82, the user cumulative point information D83, and the point history information D84 stored by the storage device 80 provided in the user card 8 of the user UP to reflect the point grant result on the user card 8.

FIG. 9 is a sequence chart illustrating an example of processing of the management system Sys in the case in which the user UP performs the collecting action by the mailing collection route RT2. In the following explanation, the processing of the management system Sys in the case in which the user UP performs the collecting action by the mailing collection route RT2 is referred to as mailing collection processing. In the present embodiment, it is assumed that the collection reception terminal 5 provided in the collection center FE has functions equivalent to the functions of the cartridge information reading device 31, the communication device 33, and the control device 40 provided in the collection box 3. In the present embodiment, it is assumed that, when the user UP has performed the collecting action by the mailing collection route RT2, the user ID for uniquely identifying the user UP is described in the collection application AP enclosed in the mail ML to the collection center FE.

As illustrated in FIG. 9, when the staff member UE of the collection center FE inputs, to the collection reception terminal 5, the user ID described in the collection application AP enclosed in the mail ML from the user UP, the collection reception terminal 5 receives the user ID and generates the user identification information D81 indicating the user ID (S201).

Subsequently, the staff member UE of the collection center FE reads, using a not-illustrated reading device, the cartridge model number information D71 stored in the storage device 70 provided in the cartridge 7 enclosed by the mail ML from the user UP. Then, the collection reception terminal 5 receives the cartridge model number information D71 read by the reading device (S203).

Subsequently, based on the cartridge model number information D71 received in step S203, the collection reception terminal 5 determines whether the cartridge 7 enclosed in the mail ML from the user UP corresponds to the cartridge 7 that can be collected by the collection center FE (S205).

Subsequently, the staff member UE of the collection center FE inputs, to the collection reception terminal 5, the number of the cartridges 7 enclosed in the mail ML from the user UP. Then, the collection reception terminal 5 generates the number of cartridges information DK indicating the input number of the cartridges 7 (S207).

Subsequently, the collection reception terminal transmits the user identification information D81 indicating the user ID received in step S201 and the number of cartridges information DK generated in step S207 to the management server 1 (S209).

Thereafter, the management server 1 executes the processing in steps S111 to S117 explained above.

Thereafter, the collection reception terminal 5 acquires the point grant notification transmitted by the point grant unit 13 in step S117 (S219).

Then, the collection reception terminal 5 notifies a point grant result to the user UP using communication means such as an e-mail (S221).

### 3. Conclusion of the Embodiment

As explained above, the management server 1 according to the present embodiment is the management server 1 that manages the cartridge 7 that stores the ink used in the printing apparatus PR, the management server 1 including the point grant unit 13 that, when the user UP has brought in “KK 1” cartridges 7 in the collecting action of bringing the cartridge 7 into the collection box 3 for collecting the cartridge 7, grants a point of “KK1*PT1” to the user UP and, when the user UP has brought in “KK 2” cartridges 7 more than the “KK1” cartridges 7 in the collecting action, grants a point of “KK2*PT2” to the user UP. The unit number of points PT2 is larger than the unit number of points PT1.

As explained above, according to the present embodiment, when the user UP has brought a large number of cartridges 7 into the collection box 3 in one collecting action, by increasing the unit number of points PT compared with the case in which the user UP has brought a small number of cartridges 7 into the collection box 3, the management server 1 increases the number of unit points per one cartridge 7 granted to the user UP. For this reason, according to the present embodiment, the user UP is urged to bring more cartridges 7 into the collection box 3 in one collecting action, whereby the number of the cartridges 7 brought into the collection box 3 in one collecting action can be increased. Therefore, it is possible to reduce an environmental load relating to collection of one cartridge 7 compared with the aspect in which the cartridges 7 are individually collected one by one as in the related art.

Thus, according to the present embodiment, compared to the aspect in which the cartridges 7 are individually collected one by one as in the related art, it is possible to greatly contribute to “significantly reducing emission of chemical substances and wastes into the atmosphere, water, and soil in order to minimize adverse effects on human health and environment” described in the target 12.4 of the SDGs.

According to the present embodiment, the user UP is urged to bring more cartridges 7 into the collection box 3 in one collecting action, whereby the number of the cartridges 7 brought into the collection box 3 in one collecting action can be increased. Therefore, it is possible to further increase a collection total amount of the cartridges 7 and reduce the used cartridges 7 not collected compared with the aspect in which the cartridges 7 are individually collected one by one as in the related art.

Thus, according to the present embodiment, compared to the aspect in which the cartridges 7 are individually collected one by one as in the related art, it is possible to more greatly contribute to “significantly reducing occurrence of wastes through occurrence prevention, reduction, recycled use, and reuse of the wastes” described in the target 12.5 of the SDGs.

According to the present embodiment, since an amount of a point corresponding to the number of the cartridges 7 brought into the collection box 3 in one collecting action is granted to the user UP, it is possible to motivate the user UP to increase the number of the cartridges 7 to be brought into the collection box 3 in one collecting action. That is, according to the present embodiment, compared to the aspect in which the cartridges 7 are individually collected one by one as in the related art, it is possible to more strongly enlighten the user UP about a reduction in an environmental load through an increase in the number of the cartridges 7 brought into the collection box 3 in one collecting action.

Thus, according to the present embodiment, compared with the aspect in which the cartridges 7 are individually collected one by one as in the related art, it is possible to more greatly contribute to “improving education, enlightenment, human capacity, and institutional functions concerning climate change mitigation, adaptation, impact reduction, and early warning” described in the target 13.3 of the SDGs.

In the present embodiment, the management server 1 includes the number information acquisition unit 11 that acquires the number of cartridges information DK indicating the number of the cartridges 7 brought into the collection box 3 in the collecting action, the cartridge 7 includes the storage device 70 that stores the cartridge model number information D71 concerning the cartridge 7, the collection box 3 includes the cartridge information reading device 31 that reads the cartridge model number information D71 from the storage device 70, the cartridge collection determination unit 41 that determines, based on a reading result of the cartridge model number information D71 by the cartridge information reading device 31, whether a product brought into the collection box 3 is the cartridge 7 that can be collected by the collection box 3, and the number of cartridges counting unit 42 that generates the number of cartridges information DK based on a determination result of the cartridge collection determination unit 41, and the number information acquisition unit 11 acquires the number of cartridges information DK generated by the number of cartridges counting unit 42 from the collection box 3.

As explained above, according to the present embodiment, the collection box 3 determines, based on the cartridge model number information D71, whether a product brought into the collection box 3 is the cartridge 7 to be collected by the collection box 3. Therefore, it is possible to more easily discriminate the cartridge 7 compared with aspects of the related art such as an aspect in which a person having a specific technique capable of discriminating a type of the cartridge 7 is disposed and an aspect in which a specific sensor device capable of discriminating the type of the cartridge 7 is disposed.

Thus, according to the present embodiment, compared with the aspect in which the person having the specific technique or the specific sensor device is disposed as in the related art, it is possible to greatly contribute to “promoting comprehensive and sustainable industrialization and increasing employment” in the industrial field relating recycling as described in the target 9.2 of SDGs.

In the present embodiment, the point can be replaced with a right to obtain a recycled product of the cartridge 7 remanufactured using the cartridge 7 brought into the collection box 3.

For this reason, according to the present embodiment, it is possible to reduce an amount of wastes of the cartridges 7 compared with an aspect in which the used cartridge 7 is not reused.

Thus, according to the present embodiment, compared to the aspect in which the cartridges 7 are individually collected one by one as in the related art, it is possible to more greatly contribute to “significantly reducing occurrence of wastes through occurrence prevention, reduction, recycled use, and reuse of the wastes” described in the target 12.5 of the SDGs.

In the present embodiment, the management server 1 includes the user management unit 14 that manages the user management information D22 relating to a history of the collecting action by the user UP, and the point grant unit 13 determines, based on the user management information D22, a quantity of a cumulative granted point granted to the user UP.

As explained above, according to the present embodiment, since a point is granted to the user UP based on the history of the collecting action by the user UP, it is possible to continuously motivate, for a longer period, the user UP to increase the number of the cartridges 7 to be brought into the collection box 3 in one collecting action compared with an aspect in which the history of the collecting action by the user UP is not considered in granting a point to the user UP.

Thus, according to the present embodiment, compared to the aspect in which the history of the collecting action by the user UP is not considered in granting a point to the user UP, it is possible to more greatly contribute to “improving education, enlightenment, human capacity, and institutional functions concerning climate change mitigation, adaptation, impact reduction, and early warning” described in the target 13.3 of the SDGs.

In the present embodiment, the collection box 3 is capable of collecting the collection box 3 in both of a case in which the ink does not remain in the ink chamber of the cartridge 7 and a case in which the ink remains in the ink chamber of the cartridge 7.

For this reason, according to the present embodiment, compared with an aspect in which the collection box 3 is capable of collecting the cartridge 7 only when the ink does not remain inside the cartridge 7, it is possible to reduce possibility of environmental contamination caused by inappropriate disposal of the ink by the user UP.

Thus, according to the present embodiment, compared with the aspect in which the collection box 3 is capable of collecting the cartridge 7 only when the ink does not remain inside the cartridge 7, it is possible to more greatly contribute to “reducing the numbers of deaths and diseases due to hazardous chemicals and air, water, and soil pollution” described in the target 3.9 of the SDGs.

According to the present embodiment, compared to the aspect in which the collection box 3 is capable of collecting the cartridge 7 only when the ink does not remain inside the cartridge 7, it is possible to more greatly contribute to “improvement of water quality through minimization of emission of hazardous chemicals” described in the target 3.9 of the SDGs.

### B. Modifications

The embodiment explained above can be variously modified. Aspects of specific modifications are exemplified below. Two or more aspects optionally selected from the following exemplifications can be combined as appropriate in a range in which the aspects do not contradict each other. In the modifications exemplified below, elements having the same actions and functions as those of the embodiment are denoted by the same reference numerals and signs referred to in the above explanation, and detailed explanation of the respective elements is omitted as appropriate.

### Modification 1

In the embodiment explained above, the case in which the cartridge 7 includes the storage device 70 that stores the cartridge model number information D71 is exemplified and explained. However, the present disclosure is not limited to such an aspect. For example, the cartridge 7 may include a symbol for indicating the cartridge model number information D71. Here, the symbol may be a display object having a pattern for indicating the cartridge model number information D71. More specifically, the symbol may be a two-dimensional code for representing the cartridge model number information D71 or may be a one-dimensional code for representing the cartridge model number information D71.

When the cartridge 7 includes the symbol, the cartridge information reading device 31 may be an imaging device that images the symbol or may be an image processing device for reading the cartridge model number information D71 from the symbol.

That is, in the present modification, the management server 1 includes the number information acquisition unit 11 that acquires the number of cartridges information DK indicating the number of the cartridges 7 brought into the collection box 3 in the collecting action, the cartridge 7 includes the symbol representing the cartridge model number information D71 concerning the cartridge 7, the collection box 3 includes the cartridge information reading device 31 that reads the cartridge model number information D71 from the symbol, the cartridge collection determination unit 41 that determines, based on a reading result of the cartridge model number information D71 by the cartridge information reading device 31, whether a product brought into the collection box 3 is the cartridge 7 that can be collected by the collection box 3, and the number of cartridges counting unit 42 that generates the number of cartridges information DK based on a determination result of the cartridge collection determination unit 41, and the number information acquisition unit 11 acquires the number of cartridges information DK generated by the number of cartridges counting unit 42 from the collection box 3.

In the present modification, the management server 1 may include the number information acquisition unit 11 that acquires the number of cartridges information DK indicating the number of the cartridges 7 brought into the collection box 3 in the collecting action, the cartridge 7 may include a symbol representing the cartridge model number information D71 relating to the cartridge 7, the collection box 3 may include the cartridge information reading device 31 that reads the symbol, the cartridge collection determination unit 41 that determines, based on a reading result by the cartridge information reading device 31, whether a product brought into the collection box 3 is the cartridge 7 that can be collected by the collection box 3, and the number of cartridges counting unit 42 that generates the number of cartridges information DK based on a determination result of the cartridge collection determination unit 41, and the number information acquisition unit 11 may acquire the number of cartridges information DK generated by the number of cartridges counting unit 42 from the collection box 3.

As explained above, according to the present modification, the collection box 3 determines, based on the symbol provided in the cartridge 7, whether a product brought into the collection box 3 is the cartridge 7 to be collected by the collection box 3. Therefore, it is possible to more easily discriminate the cartridge 7 compared with aspects of the related art such as an aspect in which a person having a specific technique capable of discriminating a type of the cartridge 7 is disposed and an aspect in which a specific sensor device capable of discriminating the type of the cartridge 7 is disposed.

Thus, according to the present embodiment, compared with the aspect in which the person having the specific technique or the specific sensor device is disposed as in the related art, it is possible to greatly contribute to “promoting comprehensive and sustainable industrialization and increasing employment” in the industrial field relating recycling as described in the target 9.2 of SDGs.

### Modification 2

In the embodiment and the modification 1 explained above, the case in which the cartridge information reading device 31 reads the cartridge model number information D71 from the cartridge 7 is exemplified and explained. However, the present disclosure is not limited to such an aspect.

For example, the cartridge information reading device 31 may be an image analysis device that reads the shape of the cartridge 7. In this case, the cartridge collection determination unit 41 may determine, based on the shape of the cartridge 7 read by the cartridge information reading device 31, whether a product brought into the collection box 3 is the cartridge 7 that can be collected by the collection box 3.

For example, the cartridge information reading device 31 may be an imaging device that images the cartridge 7. In this case, the cartridge collection determination unit 41 may determine, based on an imaging result by the cartridge information reading device 31, whether the product brought into the collection box 3 is the cartridge 7 that can be collected by the collection box 3.

### Modification 3

In the embodiment and the modifications 1 and 2 explained above, the case in which the management server 1 grants a point to the user UP when the user UP has performed the collecting action and grants a point to the user UP when the cumulative acquired point of the user UP satisfies the specific condition is exemplified and explained. However, the present disclosure is not limited to such an aspect.

For example, when the user UP performs the collecting action, the management server 1 may determine, based on the number of times the cartridge 7 to be subjected to the collecting action is recycled as a recycled product, a point granted to the user UP.

Further, for example, when the user UP has performed the collecting action, the management server 1 may determine, based on a manufacturing date of the cartridge 7 to be subjected to the collecting action, a point granted to the user UP.

### Modification 4

In the embodiment and the modifications 1 to 3 explained above, the management server 1 grants a point to the user UP, for example, when the user UP has performed the collecting action. However, the present disclosure is not limited to such an aspect. For example, when the user UP has performed the collecting action, the management server 1 may improve a grant rate of a point granted to the user UP. That is, in the present modification, the improvement of the point grant rate is an example of the “privilege”.

In the present disclosure, the “privilege” is not limited to the point, the improvement of the point grant rate, and the like. The “privilege” may be, for example, a tangible object or an intangible object having a value for the user UP such as money or a gift certificate, may be an object that motivates the user UP to perform the collecting action. or may be an object that motivates the user UP to bring more cartridges 7 into the collection box 3 in one collecting action.

### Modification 5

In the embodiment and the modifications 1 to 4 explained above, the cartridge 7 is exemplified and explained as the specific member that is the target of the collecting action. However, the present disclosure is not limited to such an aspect. The target of the collecting action in the management system Sys only has to be a reusable specific member.

Here, the specific member may be, for example, besides the cartridge 7 that stores the ink serving as the consumable item, a storage container that stores a consumable item used in the printing apparatus PR such as a toner bottle that stores toner serving as a consumable item. The specific member may be, for example, a storage container that stores a waste that occurs according to use of the printing apparatus PR such as a waste ink box that stores waste ink serving as a waste or a waste toner box that stores waste toner serving as a waste.

Further, the specific member is not limited to a member relating to the printing apparatus PR. For example, the specific member may be a member that can be reused by replacing a consumable item such as a projector including a lamp serving as a consumable item and a smartphone including a battery serving as a consumable item.

It is preferable that the specific member includes a storage device that stores member information concerning the specific member or a symbol representing the member information concerning the specific member. Here, in the embodiment explained above, the container information exemplified as the cartridge model number information D71 is an example of “member information” for identifying the specific member.

Further, the specific member is not limited to the member that can be reused by replacing the consumable item. For example, the specific member may be a member that can be reused by being disassembled into materials such as clothing composed of a fabric serving as a material and printing paper composed of a fiber serving as a material.

What is claimed is:

1. A control method for a management device that manages a storage container that stores a consumable item used in a printing apparatus, the method causing a processor of the management device to function as a granting unit configured to:
grant a privilege of a first amount to a user when the user brought in a first number of storage containers in a collecting action of bringing the storage container into collection equipment for collecting the storage container; and
grant the privilege of a second amount to the user when the user brought in a second number of storage containers more than the first number of storage containers in the collecting action, wherein
a value obtained by dividing the second amount by the second number is larger than a value obtained by dividing the first amount by the first number.

2. The control method according to claim 1, further causing the processor of the management device to function as an acquisition unit configured to acquire number information indicating a number of storage containers brought into the collection equipment in the collecting action, wherein
the storage container includes a storage device configured to store container information concerning the storage container
the collection equipment includes:
a reading device configured to read the container information from the storage device;
a product determination unit configured to determine, based on a reading result of the container information by the reading device, whether a product brought into the collection equipment is the storage container; and
a number information generation unit configured to generate the number information based on a determination result of the product determination unit, and
the acquisition unit acquires the number information generated by the number information generation unit from the collection equipment.

3. The control method according to claim 1, further causing the processor of the management device to function as an acquisition unit configured to acquire number information indicating a number of storage containers brought into the collection equipment in the collecting action, wherein
the storage container includes a symbol indicating container information concerning the storage container,
the collection equipment includes:
a reading device configured to read the symbol;
a product determination unit configured to determine, based on a reading result by the reading device, whether a product brought into the collection equipment is the storage container; and
a number information generation unit configured to generate the number information based on a determination result of the product determination unit, and
the acquisition unit acquires the number information generated by the number information generation unit from the collection equipment.

4. The control method according to claim 1, wherein the privilege is a right to obtain a storage container remanufactured using the storage container brought into the collection equipment.

5. The control method according to claim 1, further causing the processor of the management device to function as a user management unit configured to manage history information relating to a history of the collecting action by the user, wherein
the granting unit determines, based on the history information, an amount of a privilege granted to the user.

6. The control method according to claim 1, wherein the collection equipment is capable of collecting the storage container in both of a case in which the consumable item does not remain in the storage container and a case in which the consumable item remains in the storage container.

7. A management system that manages a reusable specific member, the management system comprising a granting unit configured to:
grant a privilege of a first amount to a user when the user brought in a first number of specific members in a collecting action of bringing the specific member into collection equipment for collecting the specific member; and
grant the privilege of a second amount to the user when the user brought in a second number of specific members more than the first number of specific members in the collecting action, wherein
a value obtained by dividing the second amount by the second number is larger than a value obtained by dividing the first amount by the first number.

8. The management system according to claim 7, further comprising an acquisition unit configured to acquire number information indicating a number of specific members brought into the collection equipment in the collecting action, wherein
the specific member includes a storage device configured to store member information concerning the specific member,
the collection equipment includes:
a reading device configured to read the member information from the storage device;
a product determination unit configured to determine, based on a reading result of the member information by the reading device, whether a product brought into the collection equipment is the specific member; and
a number information generation unit configured to generate the number information based on a determination result of the product determination unit, and
the acquisition unit acquires the number information generated by the number information generation unit from the collection equipment.

9. The management system according to claim 7, further comprising an acquisition unit configured to acquire number information indicating a number of specific members brought into the collection equipment in the collecting action, wherein
the specific member includes a symbol indicating member information concerning the specific member,
the collection equipment includes:
a reading device configured to read the symbol;
a product determination unit configured to determine, based on a reading result by the reading device, whether a product brought into the collection equipment is the specific member; and
a number information generation unit configured to generate the number information based on a determination result of the product determination unit, and
the acquisition unit acquires the number information generated by the number information generation unit from the collection equipment.

10. The management system according to claim 7, wherein the privilege is a right to obtain a specific member remanufactured by using the specific member brought into the collection equipment.

11. The management system according to claim 7, further comprising a user management unit configured to manage history information relating to a history of a collecting action by the user,
wherein
the granting unit determines, based on the history information, an amount of a privilege granted to the user.
